(19) United States
(12) Patent Application Publication
(10) Pub. No.: US 2026/0302355 A1
(43) Pub. Date: Oct. 1, 2026

(54) LITHIUM-ION SECONDARY BATTERY

(71) Applicant: Toyota Jidosha Kabushiki Kaisha, Toyota-shi (JP)

(72) Inventor: Shinsuke MATSUHARA, Miyoshi-shi (JP)

(73) Assignee: Toyota Jidosha Kabushiki Kaisha, Toyota-shi (JP)

(21) Appl. No.: 19/442,212

(22) Filed: Jan. 7, 2026

(30) Foreign Application Priority Data
Mar. 25, 2025 (JP) 2025-049824

(51) Int. Cl. H01M 10/0569; H01M 4/587; H01M 10/0525

(52) U.S. Cl. CPC H01M 10/0569; H01M 4/587; H01M 10/0525; H01M 2300/0028

(57) ABSTRACT

The present disclosure solves the above problem by providing a lithium-ion secondary battery including an electrode layer containing an active material and an electrolyte solution, in which the active material is a graphite active material containing pores, in the graphite active material, a volume of the pores with a pore diameter of 30 nm or less is 0.011 cc/g or more, the electrolytic solution contains an electrolyte and a solvent, and also contains at least carboxylic acid ester as the solvent, and in the electrolytic solution a proportion of the carboxylic acid ester as to the total solvent is 40% by volume or more.

### CROSS-REFERENCE TO RELATED APPLICATION

This application claims priority to Japanese Patent Application No. 2025-049824 filed on Mar. 25, 2025. The disclosure of the above-identified application, including the specification, drawings, and claims, is incorporated by reference herein in its entirety.

### BACKGROUND

### 1. Technical Field

The present disclosure relates to a lithium-ion secondary battery.

### 2. Description of Related Art

In recent years, there has been active development of batteries such as lithium-ion secondary batteries and so forth. For example, in the automotive industry, batteries for use in battery electric vehicles (BEVs), plug-in hybrid electric vehicles (PHEVs), and hybrid electric vehicles (HEVs) have been actively developed.

For example, Japanese Unexamined Patent Application Publication No. 2022-153187 (JP 2022-153187 A) discloses a lithium-ion secondary battery using an electrolytic solution that includes an electrolyte containing a lithium salt and a non-aqueous solvent containing an alkylene cyclic carbonate and methyl propionate, the electrolyte containing 30 mol % or more of a lithium salt other than LiPF₆ relative to the total amount of the lithium salts, and the non-aqueous solvent containing 75% by volume or more of the methyl propionate. Also, Japanese Unexamined Patent Application Publication No. 2019-061827 (JP 2019-061827 A) discloses a lithium-ion secondary battery including an electrolyte solution containing 50% by volume or more and 95% by volume or less of a carboxylic acid ester. Also, Japanese Unexamined Patent Application Publication No. 11-031530 (JP 11-031530 A) discloses a non-aqueous electrolytic solution secondary battery using an organic solvent consisting of propylene carbonate, ethylene carbonate, methyl propionate, and at least one or more of dimethyl carbonate, diethyl carbonate, and ethyl methyl carbonate.

### SUMMARY

There is demand for reduction of resistance from the perspective of improving battery performance. The present disclosure has been made in view of the above circumstances, and a main object thereof is to provide a lithium-ion secondary battery with reduced resistance.
[1] A lithium-ion secondary battery including an electrode layer containing an active material and an electrolyte solution, in which
the active material is a graphite active material containing pores,
in the graphite active material, a volume of the pores with a pore diameter of 30 nm or less is 0.011 cc/g or more,
the electrolytic solution contains an electrolyte and a solvent, and also contains at least carboxylic acid ester as the solvent, and
in the electrolytic solution, a proportion of the carboxylic acid ester as to total solvent is 40% by volume or more.
[2] The lithium-ion secondary battery according to [1], in which the carboxylic acid ester contains at least methyl propionate.
[3] The lithium-ion secondary battery according to [1] or [2], in which, in the electrolytic solution, a proportion of the electrolyte is 1.0 mol/L or more and 1.7 mol/L or less.
[4] The lithium-ion secondary battery according to any one of [1] to [3], in which the proportion of the carboxylic acid ester is 50% by volume or more and 80% by volume or less.
[5] The lithium-ion secondary battery according to any one of [1] to [4], in which the volume is 0.016 cc/g or less.

The present disclosure has an effect of enabling provision of a lithium-ion secondary battery with reduced resistance.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view exemplifying a lithium-ion secondary battery according to the present disclosure.

### DETAILED DESCRIPTION OF EMBODIMENTS

A lithium-ion secondary battery according to the present disclosure will be described in detail below. Note that the drawing referenced below is provided for exemplary purposes, and the sizes and shapes of the components may be exaggerated in some cases to facilitate understanding. Note that in the present disclosure, the lithium-ion secondary battery may be referred to simply as “battery”.

The lithium-ion secondary battery according to the present disclosure includes an electrode layer containing an active material and an electrolyte solution. Also, the active material is a graphite active material having pores, and in the graphite active material, the volume of the pores having a pore diameter of 30 nm or less is 0.011 cc/g or more. Further, the electrolytic solution contains an electrolyte and a solvent, and also contains at least a carboxylic acid ester as the solvent, and the proportion of the carboxylic acid ester to the total solvent in the electrolytic solution is 40% by volume or more.

According to the present disclosure, a lithium-ion secondary battery with reduced resistance is obtained by containing a graphite active material in which the volume of pores having a pore diameter of 30 nm or less is 0.011 cc/g or more, and an electrolyte solution containing at least a carboxylic acid ester as a solvent, in which the proportion of the carboxylic acid ester as to the total solvent in the electrolyte solution is 40% by volume or more.

Graphite has a theoretical capacity of 372 mAhg⁻¹, and is anticipated to be a high-capacity active material. Through extensive research into batteries using graphite, the present inventors have found that battery resistance can be suppressed by combining graphite having a predetermined amount of pores and an electrolytic solution containing a carboxylic acid ester as a solvent, at a predetermined ratio. The reason for this is unclear, but is speculated as follows. It is speculated that in a battery, the surface portion of graphite mainly functions as a reaction site, and the interior of the graphite is not fully utilized for battery reaction. In contrast, in the present disclosure, it is speculated that using graphite having a predetermined amount of pores and a predetermined electrolytic solution enables ensuring that the electrolytic solution and lithium ions are well distributed within the pores of the graphite as well, and the interior of the graphite can also function as a reaction site.

### 1. Electrode Layer

The electrode layer in the present disclosure contains the active material and the electrolyte solution.

### (1) Active Material

The active material contained in the electrode layer is the graphite active material having pores. Here, unless otherwise specified, the term “pore” in the present disclosure means an open pore that communicates with the outside of the active material, and does not mean a closed pore that does not communicate with the outside of the active material. Note that the active material may have closed pores.

Also, in the graphite active material, the volume of the pores (open pores) having a pore diameter of 30 nm or less is 0.011 cc/g or more. The volume may be 0.012 cc/g or more, may be 0.013 cc/g or more, or may be 0.014 cc/g or more. On the other hand, the volume is, for example, 0.016 cc/g or less, and may be 0.015 cc/g or less. Examples of measurement methods of the pore volume include gas adsorption using nitrogen gas, argon gas, or the like, and mercury intrusion.

The diameter of the pores contained in the graphite active material is, for example, 1000 nm or less, and may be 500 nm or less, may be 300 nm or less, or may be 100 nm or less. On the other hand, the diameter of the pores is, for example, 1 nm or more.

The form of the graphite active material is, for example, particulate. The average particle size (D₅₀) of the graphite active material is not limited in particular, but is, for example, 0.5 μm or more and 10 μm or less. D₅₀ refers to the particle size corresponding to a cumulative frequency of 50% in particle size distribution. The average particle size may be a value measured by laser diffraction scattering particle size analysis, or may be a value measured by image analysis using software.

The graphite active material may be artificial graphite or natural graphite. The electrode layer may contain just artificial graphite, may contain just natural graphite, or may contain both artificial graphite and natural graphite, as the graphite active material.

The proportion of the graphite active material as to the solid content of the electrode layer is, for example, 50% by weight or more, and may be 60% by weight or more. On the other hand, the proportion of the graphite active material is, for example, 99% by weight or less, and may be 95% by weight or less, 90% by weight or less, 80% by weight or less, or 70% by weight or less.

### (2) Electrolytic Solution

The electrolytic solution contained in the electrode layer contains an electrolyte and a solvent, and also contains at least a carboxylic acid ester as the solvent.

Carboxylic acid esters are usually represented by RCOOR′ (where R and R′ are any alkyl group or aryl group). The number of carbon atoms in R and R′ is each independently 1 or more and 5 or less, for example. R and R′ may each independently have 1, 2, 3, 4, or 5 carbon atoms. Examples of carboxylic acid esters include acetate esters such as ethyl acetate, butyl acetate, and so forth, and propionate esters such as methyl propionate and so forth. Among these, the electrolytic solution preferably contains methyl propionate. Methyl propionate is a solvent with relatively low viscosity, and it is speculated that this can reduce the viscosity of the electrolytic solution, allowing the electrolytic solution and lithium ions to permeate more deeply into the graphite active material. The electrolytic solution may contain one type of carboxylic acid ester, or may contain two or more types of carboxylic acid esters.

Also, in the electrolytic solution, the proportion of the carboxylic acid ester as to the total solvent is 40% by volume or more. The proportion of the carboxylic acid ester may be 50% by volume or more, 55% by volume or more, 60% by volume or more, or 65% by volume or more. On the other hand, the proportion of the carboxylic acid ester is, for example, 80% by volume or less, or may be 75% by volume or less, 70% by volume or less, or 65% by volume or less.

Examples of solvents contained in the electrolyte solution other than the carboxylic acid esters include cyclic esters (cyclic carbonates) such as ethylene carbonate (EC), propylene carbonate (PC), butylene carbonate (BC), and so forth, and linear esters (linear carbonates) such as dimethyl carbonate (DMC), diethyl carbonate (DEC), ethyl methyl carbonate (EMC), and so forth.

The electrolyte can include lithium salts, including inorganic lithium salts, organic lithium salts, and so forth. Examples of inorganic lithium salts include LiPF₆, LiBF₄, LiClO₄, and LiAsF₆. Examples of organic lithium salts include LiCF₃SO₃, LiN(CF₃SO₂)₂, LiN(C₂F₅SO₂)₂, LiN(FSO₂)₂, and LiC(CF₃SO₂)₃. The electrolytic solution may contain one type of electrolyte, or may contain two or more types of electrolytes.

The proportion of the electrolyte in the electrolytic solution is, for example, 1.0 mol/L or more, and may be 1.1 mol/L or more, or may be 1.2 mol/L or more, or may be 1.3 mol/L or more, or may be 1.4 mol/L or more. It is speculated that when the proportion of the electrolyte is too low, there is concern that there will be few reaction sites in the graphite. On the other hand, the proportion of the electrolyte is, for example, 1.7 mol/L or less, and may be 1.6 mol/L or less, or may be 1.5 mol/L or less. It is speculated that when the proportion of electrolyte is too high, the viscosity of the electrolyte solution will become too high, and the electrolytic solution may not sufficiently permeate into the pores.

### (3) Electrode Layer

The electrode layer may be a cathode layer or an anode layer, with the latter being preferred. The reason is that a battery with a higher capacity is obtained.

The electrode layer may contain at least one of a conductive material and a binder as necessary.

Examples of electrically conductive materials include carbon-based electrically conductive materials, metal particles, and electrically conductive polymers. Examples of carbon-based electrically conductive materials include particulate materials such as acetylene black (AB) Ketjen black (KB) and so forth, and fibrous materials such as vapor-grown carbon fibers (VGCFs), carbon nanotubes (CNTs), carbon nanofibers (CNFs) and so forth.

Examples of binders include rubber-based binders such as styrene-butadiene rubber (SBR), butadiene rubber (BR), and so forth, polycarboxylic-acid-based binders such as carboxymethyl cellulose and so forth, and fluoride-based binders such as polyvinylidene fluoride (PVdF) and so forth.

The thickness of the electrode layer is not limited in particular, but is, for example, 30 μm or more and 1000 μm or less.

### 2. Lithium-Ion Secondary Battery

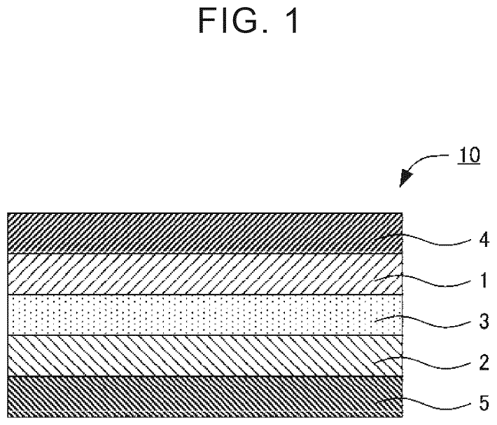

FIG. 1 is a schematic cross-sectional view exemplifying a lithium-ion secondary battery according to the present disclosure. The lithium-ion secondary battery 10 illustrated in FIG. 1 includes a cathode layer 1, an anode layer 2, an electrolyte layer 3 disposed between the cathode layer 1 and the anode layer 2, a cathode current collector 4 that collects current from the cathode layer 1, and an anode current collector 5 that collects current from the anode layer 2. In the lithium-ion secondary battery 10, the cathode layer 1 or the anode layer 2 is the electrode layer described above.

Hereinafter, a battery in which the electrode layer is an anode layer will be described.

### (1) Anode Layer

The anode layer is the same as that described in “1. Electrode layer”.

### (2) Cathode Layer

The cathode layer is a layer containing at least a cathode active material. Also, the cathode layer may contain at least one of an electrolytic solution, a conductive material, and a binder, as necessary. The electrolytic solution, the conductive material, and the binder are the same as those described in “1. Electrode layer”.

Examples of the cathode active material include oxide active materials. Examples of the oxide active material include layered rock-salt active materials such as LiCoO₂, LiMnO₂, LiNiO₂, LiVO₂, LiNi_{1/3}Co_{1/3}Mn_{1/3}O₂, and so forth, spinel active materials such as LiMn₂O₄, Li₄Ti₅O₁₂, Li(Ni_{0.5}Mn_{1.5})O₄, and so forth, and olivine active materials such as LiFePO₄, LiMnPO₄, LiMnFePO₄, LiNiPO₄, and LiCoPO₄, and so forth.

The form of the cathode active material is, for example, particulate. The average particle size (D₅₀) of the cathode active material is not limited in particular, but is, for example, 10 nm or more, and may be 100 nm or more. On the other hand, the average particle size (D₅₀) of the cathode active material is, for example, 50 μm or less, and may be 20 μm or less. D₅₀ is as described above.

The proportion of the cathode active material in the cathode layer is, for example, 50% by weight or more and 99% by weight or less. The thickness of the cathode layer is, for example, 30 μm or more and 1000 μm or less.

### (3) Electrolyte Layer

The battery according to the present disclosure usually includes an electrolyte layer. The electrolyte layer is a layer that is formed between the cathode layer and the anode layer, and contains at least an electrolyte. The electrolyte is usually the electrolytic solution described in “1. Electrode layer”.

The electrolyte layer may be a layer in which a separator, which is a porous membrane, is impregnated with the above-mentioned electrolyte solution. The material of the separator may be an organic material or may be an inorganic material. Specific examples include polyethylene (PE), polypropylene (PP), cellulose, polyvinylidene fluoride, polyamide, polyimide, and so forth. The separator may be a nonwoven fabric such as a resin nonwoven fabric, a glass fiber nonwoven fabric, and so forth, or a ceramic porous membrane. Also, the separator may have a single-layer structure or a multilayer structure. Examples of the separator having a laminated structure include a separator having a two-layer structure of PE-PP, and a separator having a three-layer structure of PP-PE-PP or PE-PP-PE.

### (4) Other Configurations

The battery according to the present disclosure may include members such as a cathode current collector, an anode current collector, terminals, a battery case, and so forth. These members are not limited in particular, and any conventionally known members used in batteries can be used. The lithium-ion secondary battery may be a stacked battery or a wound battery. Also, the lithium-ion secondary battery may be a monopolar battery or a bipolar battery.

### (5) Usage

The usage of the battery is not limited in particular, but examples include power sources for vehicles such as HEVs, PHEVs, BEVs, gasoline-powered automobiles, diesel-powered automobiles, and so forth. In particular, the battery is preferably used as a traction power source for HEVs, PHEVs, or BEVs. Also, the battery may also be used as a power source for moving objects other than vehicles (e.g., trains, ships, and aircraft), or may be used as a power source for electrical products such as information processing devices and so forth.

Note that the present disclosure is not limited to the above embodiment. The above embodiment is merely exemplary, and any structure having substantially the same configuration as, and having similar functions and effects to, the technical idea described in the claims of the present disclosure is encompassed by the technical scope of the present disclosure.

### Comparative Example 1

### Preparation of Anode

As an anode active material, artificial graphite (graphite active material A) having pores with a pore diameter of 30 nm or less and a pore volume of 0.004 cc/g was prepared. Note that the pore diameter and pore volume were measured by gas adsorption based on the standard (JIS Z8831-2:2010). As a measuring device, a BELLSORP MAX II manufactured by Microtrac-BEL was used, and nitrogen gas was used as the adsorption gas.

The graphite active material A, a binder (SBR), and a thickener (CMC) were added to a solvent in a weight ratio of 98:1:1, and mixed, to prepare an anode slurry. An anode having an anode current collector (Cu foil; 10 μm) and an anode layer was prepared by a coating method using the above anode slurry. Note that the anode layer was pressed to a predetermined thickness.

### Fabrication of Evaluation Battery

Using the above anode, a battery for evaluation (liquid-based battery, wound battery) was fabricated. The materials of each member are as follows.

For the cathode layer, a layer containing an oxide active material (NCM: LiNi_{1/3}Co_{1/3}Mn_{1/3}O₂), a carbon-based conductive material (AB), and a fluorine-based binder (PVdF), was used. Note that the weight ratio of the oxide active material, the carbon-based conductive material, and the fluorine-based binder, in the cathode layer, was 92:5:3. The cathode layer was pressed to a predetermined thickness.

For the cathode current collector, Al foil having a thickness of 15 μm was used.

The electrolyte layer was a 24-μm-thick separator having a three-layer structure of polypropylene (PP)-polyethylene (PE)-polypropylene (PP). Note that one face of the separator (face facing cathode layer) was coated with ceramic to a thickness of 4 μm.

Also, LiPF₆ was used as the electrolyte in the electrolytic solution, and ethylene carbonate (EC) and methyl propionate (MP) were used as the solvent. The electrolyte concentrations (salt concentrations) and the solvent proportions are shown in Table 1.

Using the above-described members, a battery was fabricated as follows. First, an electrode group was fabricated by winding an anode (anode layer and anode current collector) and a cathode (cathode layer and cathode current collector) with a separator interposed therebetween. Next, current collector plates with lids were welded to both ends of the electrode group, inserted into a case, and the lid plates were welded to the case. The electrolyte solution was poured into a liquid injection hole, and then the liquid injection hole was sealed using a screw. This was left standing for a certain period of time, to allow each layer to be impregnated with the electrolytic solution. After the initial charge, aging was then carried out at 60° C. In this way, a battery for evaluation was fabricated.

### Example 1 to Example 9 and Comparative Example 1 to Comparative Example 5

As shown in Table 1, evaluation batteries were fabricated in the same manner as in Comparative Example 1, except that at least one of the type of graphite active material, salt concentration, and proportions of EC and MP was changed. Note that graphite active material B in Table 1 is an artificial graphite having a volume of 0.011 cc/g of pores with a diameter of 30 nm or less. Also, graphite active material C in Table 1 is an artificial graphite having a volume of 0.016 cc/g of pores with a diameter of 30 nm or less.

### Evaluation

### Measurement of Battery Resistance

The battery resistance at 25° C. was measured as follows.

First, the evaluation batteries fabricated in each of the Examples and Comparative Examples were left standing in a thermostatic chamber for 3 hours such that the ambient temperature was 25° C. Thereafter, charging was carried out at 2C for 10 seconds, in a state of SOC of 50%. Resistance value was calculated from voltage change value and current value, based on Ohm's law. Relative evaluation was performed, with the resistance value in Comparative Example 3 as 100%. Results are shown in Table 1.

TABLE 1

| | | | Electrolytic solution | | | |
|---|---|---|---|---|---|---|
| | Graphite | Pore | Salt | EC | MP | Battery |
| | active | volume | concentration | (% by | (% by | resistance |
| | material | (cc/g) | (M) | volume) | volume) | (%) |
| Comparative | A | 0.004 | 1.1 | 70 | 30 | 105 |
| Example 1 | | | | | | |
| Comparative | A | 0.004 | 1.1 | 60 | 40 | 103 |
| Example 2 | | | | | | |
| Comparative | B | 0.011 | 1.1 | 70 | 30 | 100 |
| Example 3 | | | | | | |
| Example 1 | B | 0.011 | 1.1 | 60 | 40 | 92 |
| Comparative | B | 0.011 | 1.1 | 80 | 20 | 106 |
| Example 4 | | | | | | |
| Example 2 | B | 0.011 | 1.1 | 50 | 50 | 91 |
| Example 3 | B | 0.011 | 1.1 | 40 | 60 | 89 |
| Example 4 | B | 0.011 | 1.1 | 30 | 70 | 94 |
| Example 5 | B | 0.011 | 1.1 | 20 | 80 | 96 |
| Example 6 | B | 0.011 | 1.0 | 60 | 40 | 98 |
| Example 7 | B | 0.011 | 1.4 | 60 | 40 | 96 |
| Example 8 | B | 0.011 | 1.7 | 60 | 40 | 97 |
| Comparative | A | 0.004 | 1.7 | 60 | 40 | 103 |
| Example 5 | | | | | | |
| Example 9 | C | 0.016 | 1.1 | 60 | 40 | 94 |

As shown in Table 1, Examples 1 to 9 had lower battery resistance than Comparative Examples 1 to 5, confirming that the battery according to the present disclosure has suppressed battery resistance. Also, as shown in Examples 1 to 5, it was suggested that the battery resistance may increase as the proportion of carboxylic acid ester (methyl propionate) increases, and it was suggested that the proportion of carboxylic acid ester is preferably 80% by volume or less.

What is claimed is:

1. A lithium-ion secondary battery including an electrode layer containing an active material and an electrolyte solution, wherein
the active material is a graphite active material containing pores,
in the graphite active material, a volume of the pores with a pore diameter of 30 nm or less is 0.011 cc/g or more,
the electrolytic solution contains an electrolyte and a solvent, and also contains at least carboxylic acid ester as the solvent, and
in the electrolytic solution, a proportion of the carboxylic acid ester as to total solvent is 40% by volume or more.

2. The lithium-ion secondary battery according to claim 1, wherein the carboxylic acid ester contains at least methyl propionate.

3. The lithium-ion secondary battery according to claim 1, wherein in the electrolytic solution, a proportion of the electrolyte is 1.0 mol/L or more and 1.7 mol/L or less.

4. The lithium-ion secondary battery according to claim 1, wherein the proportion of the carboxylic acid ester is 50% by volume or more and 80% by volume or less.

5. The lithium-ion secondary battery according to claim 1, wherein the volume is 0.016 cc/g or less.
